(19) United States
(12) Patent Application Publication
(10) Pub. No.: US 2023/0417521 A1
(43) Pub. Date: Dec. 28, 2023

(54) LIGHTED ARROW SHAFT

(71) Applicant: FERADYNE OUTDOORS, LLC, Superior, WI (US)

(72) Inventors: Sam Voigt, Duluth, MN (US); Kevin Berggren, Duluth, MN (US)

(21) Appl. No.: 18/213,633

(22) Filed: Jun. 23, 2023

Related U.S. Application Data
(60) Provisional application No. 63/366,909, filed on Jun. 23, 2022.

(51) Int. Cl. F42B 6/06; F21V 33/00; F21V 8/00

(52) U.S. Cl. CPC F42B 6/06; F21V 33/008; G02B 6/001; F21Y 2115/10

(57) ABSTRACT

A lighted arrow shaft includes a cylindrical shaft. The lighted arrow shaft includes a light dispersing material disposed within the shaft. The lighted arrow shaft includes a light source connected to the light dispersing material and disposed within the shaft. The lighted arrow shaft includes a power source in electrical communication with the light source and disposed within the shaft.

### CROSS-REFERENCE TO RELATED APPLICATION

This application claims priority to U.S. Patent Application No. 63/366,909, filed Jun. 23, 2022, entitled “LIGHTED ARROW SHAFT”, which is incorporated herein by reference in its entirety.

### FIELD

This disclosure relates generally to the field of archery. More particularly, this disclosure relates to shafts for an arrow such as, but not limited to, a lighted shaft for an arrow.

### BACKGROUND

A lighted arrow allows an archer to be able to see the arrow more easily in flight, see the point of arrow impact, and recover the arrow after a shot, especially at night. Being able to observe the arrow in flight and see the point of impact helps the archer to diagnose problems with shooting form or bow setup and make appropriate adjustments. Perhaps more importantly, a lighted arrow shaft allows the archer to recover the arrow more easily.

### SUMMARY

In some embodiments, a device includes a shaft. In some embodiments, the device includes a light dispersing material disposed within the shaft. In some embodiments, the device includes a light source connected to the light dispersing material. In some embodiments, the device includes a power source in electrical communication with the light source.

In some embodiments, the shaft is translucent.

In some embodiments, the shaft is opaque and comprises a plurality of apertures.

In some embodiments, the light source is a light emitting diode.

In some embodiments, the light emitting diode is configured to emit a red light or a green light.

In some embodiments, the light emitting diode is configured to emit a plurality of different light colors.

In some embodiments, the light dispersing material is a fiber optic cable.

In some embodiments, the fiber optic cable comprises a plurality of slits or abrasions.

In some embodiments, the device includes a switch configured to enable or disable the power source.

In some embodiments, the device is an arrow.

In some embodiments, the shaft has a first length and the light dispersing material has a second length, wherein the first length is greater than the second length.

In some embodiments, the second length is less than half of the first length.

In some embodiments, a lighted arrow shaft includes a cylindrical shaft. In some embodiments, the lighted arrow shaft includes a light dispersing material disposed within the shaft. In some embodiments, the lighted arrow shaft includes a light source connected to the light dispersing material and disposed within the shaft. In some embodiments, the lighted arrow shaft includes a power source in electrical communication with the light source and disposed within the shaft.

In some embodiments, the shaft is translucent.

In some embodiments, the shaft is opaque and comprises a plurality of apertures.

In some embodiments, the light source is a light emitting diode.

In some embodiments, the light emitting diode is configured to emit a red light or a green light.

In some embodiments, the light emitting diode is configured to emit a plurality of different light colors.

In some embodiments, the light dispersing material is a fiber optic cable.

In some embodiments, the fiber optic cable comprises a plurality of slits or abrasions.

In some embodiments, the lighted arrow shaft includes a switch configured to enable or disable the power source.

In some embodiments, the shaft has a first length and the light dispersing material has a second length, wherein the first length is greater than the second length.

In some embodiments, the second length is less than half of the first length.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a perspective view of a lighted arrow shaft, according to some embodiments.

FIG. 2 shows an exploded view of the lighted arrow shaft of FIG. 1, according to some embodiments.

FIG. 3 shows a side view of the lighted arrow shaft of FIGS. 1-2, according to some embodiments.

Like reference numbers represent the same or similar parts throughout.

### DETAILED DESCRIPTION

Embodiments of this disclosure include a lighted arrow. In particular, the lighted arrow includes a lighted shaft. In some embodiments, the lighted arrow can include a fiber optic cable and a light source such as, but not limited to, a light emitting diode (LED). In some embodiments, the fiber optic cable can provide the light along the length of the arrow shaft. In some embodiments, the lighted arrow can make it easier for archers or bow fishermen to see an arrow upon firing and to assist in arrow locating and retrieving.

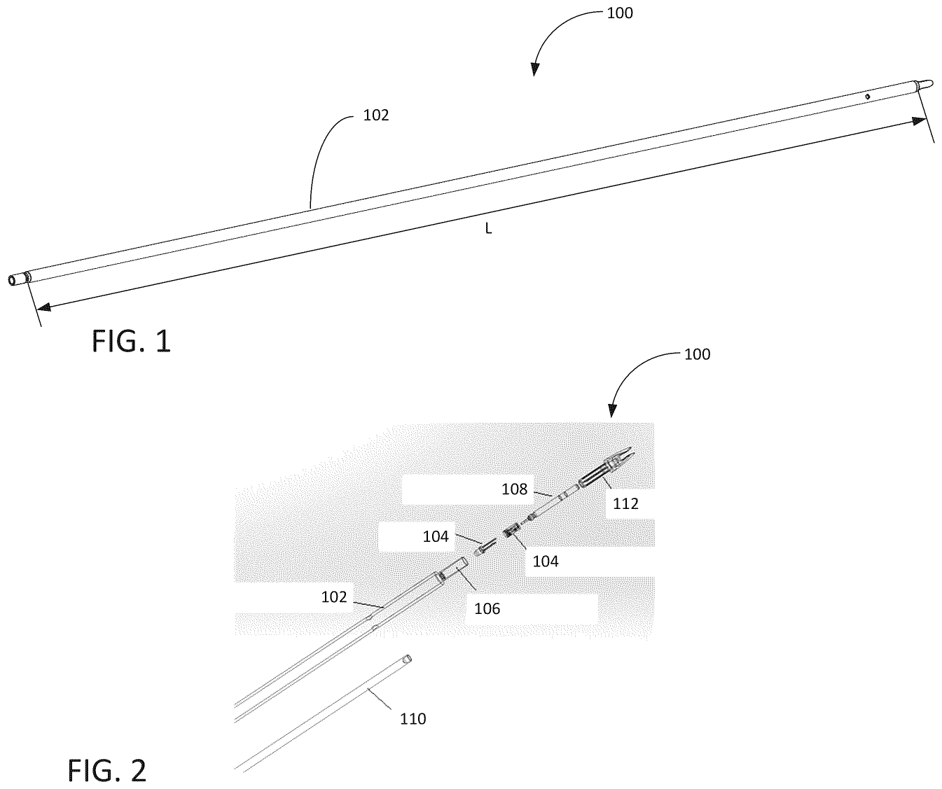

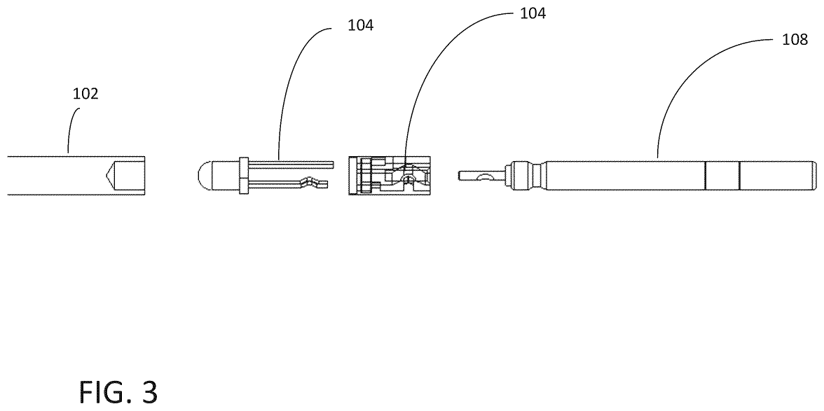

FIG. 1 shows a perspective view of a lighted arrow shaft 100, according to some embodiments. FIG. 2 shows an exploded view of the lighted arrow shaft 100 of FIG. 1, according to some embodiments. FIG. 3 shows a side view of the lighted arrow shaft of FIGS. 1-2, according to some embodiments. FIGS. 1-3 will be referred to collectively unless specifically noted otherwise.

As illustrated, the lighted arrow shaft 100 includes a shaft 102, a light source 104, a housing 106, a power source 108, a light dispersing material 110, and a nock 112. The light source 104, the housing 106, the power source 108, and the light dispersing material 110 are disposed within the shaft 102.

The lighted arrow shaft 100 can include the light source 104 and the light dispersing material 110 for lighting a length L of the lighted arrow shaft 100. In some embodiments, the lighted arrow shaft 100 can be lit along a length that is less than the length L. For example, the lighted arrow shaft 100 can be lit for half the length L, a quarter of the length L, or any other variation that is less than the length L.

In some embodiments, the shaft 102 can be made of a translucent material. In some embodiments, the lighted arrow shaft 100 can be made of an opaque material but have one or more apertures formed in the lighted arrow shaft 100 along the length L to allow light to be emitted from the lighted arrow shaft 100. The principles of this lighted arrow shaft are equally applicable to all forms of transparent or translucent materials. In addition, opaque materials may also be used when slots, holes, or other apertures are provided to allow the light to escape. Accordingly, the present disclosure is not limited to any type of material or fabrication method for producing the device. In some embodiments, suitable materials for the shaft 102 include, but are not limited to, plastic, polycarbonate, compounds thereof and the like, all of which are well known in the art for their suitability for arrows.

In some embodiments, the light source 104 can be a light emitting diode (LED) or the like. In some embodiments, the light source 104 is a battery-powered light source. In some embodiments, the light source 104 can have a replaceable battery. In some embodiments, the light source 104 can include a rechargeable battery as the power source 108.

In some embodiments, the light source 104 can include a switch operable by a user to turn on the light source 104. In some embodiments, the light source 104 can be operable via a switch engaged by force applied to the lighted arrow shaft 100 so that the lighted arrow shaft 100 is lit during use. In some embodiments, the light source 104 can remain lit for a predetermined period of time such as, but not limited to, 1 minute, 2 minutes, 3 minutes, or more. It is to be appreciated that these time periods are examples and can vary below 1 minute or above 3 minutes. In some embodiments, the light source 104 can remain lit until the user switches the light source 104 off. In some embodiments, the light source 104 may be a single color. In some embodiments, the light source 104 can be a variable color light source selectable by the user by, for example, a switch or the like. In some embodiments, the color of the light source 104 can be red or green. In some embodiments, the light source 104 can have a color that is visible during the night but does not cause night blindness of the user.

In some embodiments, the lighted arrow shaft 100 can weigh less than 1,400 grains. In some embodiments, the lighted arrow shaft 100 can be made to weigh more than 1,400 grains to provide a weighted arrow such as, but not limited to, for bowfishing or the like.

In some embodiments, the power source 108 can be a tubular dry cell battery, such as (but not limited to) a common alkaline, zinc-air, lithium ion, or other small cell currently known or in use today.

In some embodiments, the light dispersing material 110 includes a fiber optic cable. In some embodiments, the fiber optic cable can be scored or roughened to increase a brightness of the lighted arrow shaft 100.

In some embodiments, the light source 104, housing 106, and light dispersing material 110 may form an integrated package. Various other sources of these components, and alternate arrangements are possible. Although separate power source 108, light source 104, and switch are described, those skilled in the art will realize that integrated assemblies of some or all of these components may also be used. Accordingly, the concepts, apparatus, and techniques described herein are not limited to any particular packaging of these components.

Although the functionality of light source 104 may, in some exemplary embodiments, be provided by a light emitting diode (LED), those skilled in the art will realize that light sources other than LEDs may also be used. Accordingly, the concepts, systems, and techniques described herein are not limited to any particular type of light source.

In other embodiments, the lighted arrow shaft 100 may comprise a mechanically-maintained type of switch, also known as a latching, push button, or push on-push off switch, where the switch is depressed into the nock to turn on the light source and depressed again to turn off the light source. These mechanically-maintained type switches operate similarly to a ballpoint pen click action or a push on/off cabinet latch. In some embodiments, the switch may be depressed by the force of the bowstring making contact with the switch alter the bowstring is released. With this type switch, the light source 104 can remain on until the switch is depressed again to move the switch hack to the open position. In these embodiments, the switch may be depressed by making contact with a bowstring or any other device or tool that fits in the bowstring-receiving slot. In such an embodiment, a reset aperture is not required to turn the light source off. In some embodiments, the lighted arrow shaft 100 may include an electronically-maintained (or electronic) switch as an alternative to a mechanically-maintained/mechanical switch. In such a device, the bowstring would make contact with a momentary type switch configured to send a signal to an electrical circuit configured to receive the input and to toggle the light source 104 on and off. The electronic switch may further comprise a piezoelectric element that generates an electrical impulse that is sent to the electronic circuit configured to receive the input to toggle the light source on and off. In such an embodiment, a reset aperture is not required to turn the light source off.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

1. A device, comprising:
a shaft;
a light dispersing material disposed within the shaft;
a light source connected to the light dispersing material; and
a power source in electrical communication with the light source.

2. The device of claim 1, wherein the shaft is translucent.

3. The device of claim 1, wherein the shaft is opaque and comprises a plurality of apertures.

4. The device of claim 1, wherein the light source is a light emitting diode.

5. The device of claim 4, wherein the light emitting diode is configured to emit a red light or a green light.

6. The device of claim 4, wherein the light emitting diode is configured to emit a plurality of different light colors.

7. The device of claim 1, wherein the light dispersing material is a fiber optic cable.

8. The device of claim 7, wherein the fiber optic cable comprises a plurality of slits or abrasions.

9. The device of claim 1, comprising a switch configured to enable or disable the power source.

10. The device of claim 1, wherein the device is an arrow.

11. The device of claim 1, wherein the shaft has a first length and the light dispersing material has a second length, wherein the first length is greater than the second length.

12. The device of claim 11, wherein the second length is less than half of the first length.

13. A lighted arrow shaft, comprising:
a cylindrical shaft;
a light dispersing material disposed within the shaft;
a light source connected to the light dispersing material and disposed within the shaft; and
a power source in electrical communication with the light source and disposed within the shaft.

14. The lighted arrow shaft of claim 13, wherein the shaft is translucent.

15. The lighted arrow shaft of claim 13, wherein the shaft is opaque and comprises a plurality of apertures.

16. The lighted arrow shaft of claim 13, wherein the light source is a light emitting diode.

17. The lighted arrow shaft of claim 16, wherein the light emitting diode is configured to emit a red light or a green light.

18. The lighted arrow shaft of claim 16, wherein the light emitting diode is configured to emit a plurality of different light colors.

19. The lighted arrow shaft of claim 13, wherein the light dispersing material is a fiber optic cable.

20. The lighted arrow shaft of claim 19, wherein the fiber optic cable comprises a plurality of slits or abrasions.
